(19) United States
(12) Patent Application Publication
(10) Pub. No.: US 2026/0094997 A1
(43) Pub. Date: Apr. 2, 2026

(54) CONNECTOR AND CONNECTOR ASSEMBLY

(71) Applicant: SUMITOMO WIRING SYSTEMS, LTD., Mie (JP)

(72) Inventor: Toru TAKAHASHI, Mie (JP)

(21) Appl. No.: 19/335,362

(22) Filed: Sep. 22, 2025

(30) Foreign Application Priority Data
Sep. 27, 2024 (JP) 2024-168004

(51) Int. Cl. H01R 13/641; H01R 13/627

(52) U.S. Cl. CPC H01R 13/641; H01R 13/6272

(57) ABSTRACT

A connector includes a housing including a lock arm, and a detection member. The lock arm extends rearward in a cantilever shape from an outer surface of the housing. The detection member includes a detection member main body, an elastic arm portion extending forward in a cantilever shape from the detection member main body, and an abutting portion formed at an extension end portion of the elastic arm portion and restricting movement from an initial position to a detection position by engaging with the lock arm from behind. An excessive bending restriction portion restricting excessive bending of the lock arm by engaging with the extension end portion of the lock arm is formed at the outer surface of the housing.

### CROSS-REFERENCE TO RELATED APPLICATIONS

This application is based on and claims priority from Japanese Patent Application No. 2024-168004, filed on Sep. 27, 2024, with the Japan Patent Office, the disclosure of which is incorporated herein in its entirety by reference.

### TECHNICAL FIELD

The present disclosure relates to a connector and to a respective connector assembly.

### BACKGROUND

A connector as described in Japanese Patent Laid-Open Publication No. 2014-099332 is known as a connector including a fitting detection function via a detection member. This connector includes a lock arm extending rearward in a cantilever shape from a housing main body and a detection member provided so as to be movable forward from an initial position to a detection position. The detection member includes an elastic arm portion extending diagonally upward and forward in a cantilever shape, and an abutting portion formed at an extension end portion of the elastic arm portion and restricting a movement from the initial position of the detection member to the detection position by engaging with the lock arm from behind. A release operation portion is formed at a rear end (distal end) of the lock arm. A pair of left and right wall portions and a bridge portion connecting upper ends of the wall portions are formed on a top surface of a housing. An excessive bending restriction portion restricting excessive upward bending of the lock arm is formed at the bridge portion by engaging with the release operation portion locking from below.

### SUMMARY

It is an object to allow improving operability of a connection operation of a connector to a mating connector.

This object is solved according to the invention by the features of the independent claims. Particular embodiments of the invention are subject of the dependent claims.

According to one aspect, there is provided a connector fittable to a mating connector, the connector including: a housing including at least one lock arm; and a detection member mounted onto the housing (particularly from behind) and movable forward from an initial position to a detection position, in which the lock arm extends rearward in a cantilever shape from an outer surface of the housing, the detection member includes a detection member main body, an elastic arm portion extending forward in a cantilever shape from the detection member main body, and an abutting portion formed at (particularly an extension end portion of) the elastic arm portion and restricting a movement from the initial position to the detection position by engaging with the lock arm (particularly from behind), an excessive bending restriction portion is formed at an outer surface of the housing, the excessive bending restriction portion restricting excessive bending of the lock arm by engaging with an extension end portion of the lock arm, and at least one protuberance is formed on at least one of the extension end portion of the lock arm or the excessive bending restriction portion, the protuberance restricting forward movement of the lock arm by engaging with the other during excessive bending restriction.

When fitting the connector to the mating connector, the lock arm undergoes bending deformation, and in conjunction therewith, the elastic arm portion of the detection member also undergoes bending deformation.

When the mating connector and the connector are properly fitted to each other, only the lock arm particularly is returned and the elastic arm portion remains in the bending-deformed state.

Subsequently, it is possible to detect that the mating connector and the connector have reached a properly fitted state by causing the detection member to move from the initial position to the detection position.

Before fitting the connector to the mating connector, when a force or the like is unexpectedly applied to the detection member to cause the detection member to be pushed from the initial position toward the detection position, and the lock arm particularly is lifted due to the abutting portion of the elastic arm portion engaging with the lock arm substantially from behind, excessive bending of the lock arm particularly is restricted due to the extension end portion of the lock arm engaging with the excessive bending restriction portion.

When particularly further pressing the detection member from this state, the entire lock arm undergoes bending deformation and the extension end portion of the lock arm particularly attempts to move forward relative to the excessive bending restriction portion. However, in the connector of the present disclosure, forward movement of the lock arm particularly is restricted due to the protuberance formed on at least one of the extension end portion of the lock arm or the excessive bending restriction portion engaging with the other.

Therefore, the extension end portion of the lock arm detaches from the excessive bending restriction portion and the abutting portion of the detection member does not slip underneath the lock arm.

Accordingly, overall operability of the connection operation is improved.

According to a particular embodiment, the lock arm preferably extends diagonally upward and rearward from an upper surface of the housing.

Particularly, the excessive bending restriction portion preferably restricts excessive upward bending of the lock arm by engaging with the extension end portion of the lock arm from above.

Because the lock arm extends diagonally upward and rearward from the upper surface of the housing, the lock arm is more easily lifted due to the abutting portion of the elastic arm portion engaging with the lock arm from behind.

However, as described above, excessive bending of the lock arm is restricted due to the extension end portion of the lock arm engaging with the excessive bending restriction portion and forward movement of the lock arm is restricted by the protuberance.

Further particularly, a lower-side restriction surface is preferably formed at an extension portion of the lock arm.

Further particularly, the excessive bending restriction portion preferably includes an upper-side restriction surface to contact the lower-side restriction surface during excessive bending restriction.

The upper-side restriction surface is preferably a tapered surface sloping downward as the upper-side restriction surface extends forward.

Because the upper-side restriction surface particularly is a tapered surface, the lower-side restriction surface is more easily caused to closely contact the upper-side restriction surface, and the lock arm is more easily and securely fixed by the excessive bending restriction portion.

Further particularly, the protuberance is preferably formed on the lower-side restriction surface of the lock arm.

Further particularly, the excessive bending restriction portion preferably includes a front-side engagement surface with which the protuberance engages from behind during forward movement restriction.

The front-side engagement surface is preferably a tapered surface sloping upward or outward as the front-side engagement surface extends forward.

Because the front-side engagement surface is a tapered surface, the protuberance engages more strongly with and detaches less likely from the front-side engagement surface, and forward movement restriction of the lock arm by the protuberance can be performed firmly.

Further particularly, a pair of the protuberances are preferably provided substantially in parallel, and the pair of protuberances are preferably connected by at least one rib so as to form a gate shape that substantially opens at a front.

A finger or jig is more easily hooked onto the rib when unlocking the lock arm and release performance is more easily enhanced. Rigidity is increased by connecting the pair of protuberances with the rib, and deformation of the rib by an external force is more easily suppressed.

Further particularly, the protuberance preferably includes a rear-side engagement surface engaging with the front-side engagement surface from behind. The rear-side engagement surface is preferably a tapered surface sloping upward or outward as the rear-side engagement surface extends forward.

Because the rear-side engagement surface is a tapered surface, the rear-side engagement surface can more easily be caused to closely contact the front-side engagement surface, and forward movement restriction of the lock arm can be more firmly performed by the protuberance.

According to another aspect of the invention, there is provided a connector assembly comprising a connector according to the above aspect or a particular embodiment thereof and a mating connector connectable therewith.

According to the present disclosure, it is possible to improve overall operability of a connector and a corresponding connector assembly, particularly by suppressing the detection member slipping under the lock arm and improperly moving to the detection position.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector as seen diagonally from a front side thereof.

FIG. 2 is a front view of the connector as seen from the front side thereof.

FIG. 3 is a cross-sectional view along A-A in FIG. 2.

FIG. 4 is a cross-sectional view at a cross-sectional position A-A in FIG. 2 showing a state before a mating connector and the connector are fitted to each other.

FIG. 5 is a cross-sectional view at the cross-sectional position A-A in FIG. 2 showing an initial fitting state of the mating connector to the connector.

FIG. 6 is a cross-sectional view at the cross-sectional position A-A in FIG. 2 showing a semi-fitting state of the mating connector to the connector.

FIG. 7 is a cross-sectional view at the cross-sectional position A-A in FIG. 2 showing a state in which the mating connector and the connector are properly fitted to each other.

FIG. 8 is a cross-sectional view at the cross-sectional position A-A in FIG. 2 showing a state in which a detection member is midway from an initial position toward a detection position.

FIG. 9 is a cross-sectional view at the cross-sectional position A-A in FIG. 2 showing a state in which the detection member has reached the detection position.

FIG. 10 is a cross-sectional view at the cross-sectional position A-A in FIG. 2 showing a state in which the detection member is pressed forward from the initial position to the detection position before the mating connector and the connector are fitted to each other.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

“Opposite” in the present specification indicates surfaces or members being at positions right in front of each other, and means not only the surfaces or members being at positions perfectly in front of each other, but also the surfaces or members being at positions partially in front of each other. “Opposite” in the present specification means both another member different from two parts being interposed between the two parts and nothing being present between the two parts.

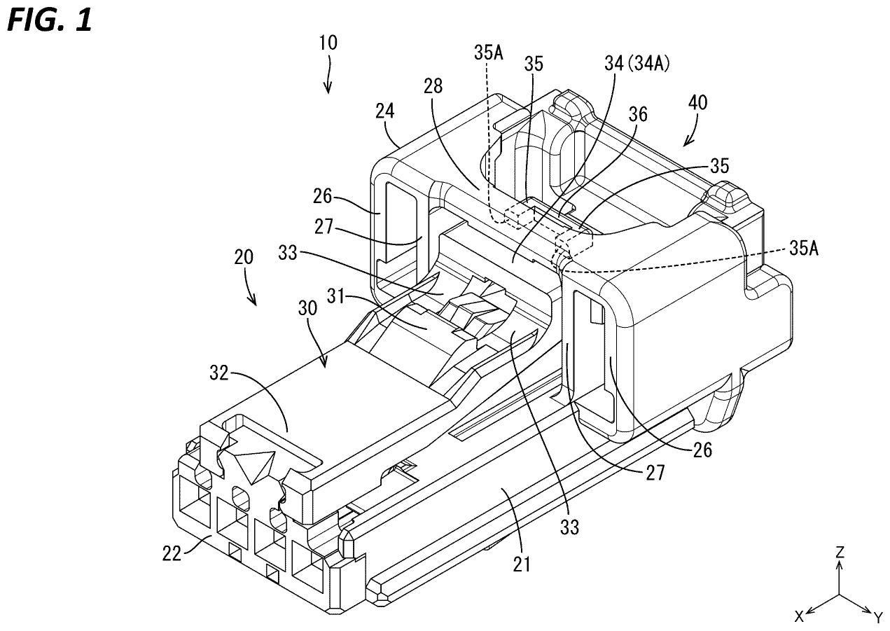

An embodiment of the present disclosure will be described with reference to FIGS. 1 to 10. In the following description, a direction indicated by a Z-arrow is referred to as an upward direction, a direction indicated by an X-arrow is referred to as a forward direction, and a direction indicated by a Y-arrow is referred to as a leftward direction. Note that only some of a plurality of identical members may be denoted by a reference sign and other members may not be denoted by the reference sign.

### (Connector 10)

A connector 10 at least partly is fittable to a mating connector 50. The connector 10 includes a housing 20 including at least one lock arm 30, and at least one detection member 40 mounted onto the housing 20 from a mounting direction such as substantially from behind and/or movable along a displacement direction (particularly substantially forward) from an initial position towards or to a detection position.

Note that in the following description, a fitting surface side of both of the connectors 10 and 50 is defined as a front side with respect to a front-rear direction.

### (Mating Connector 50)

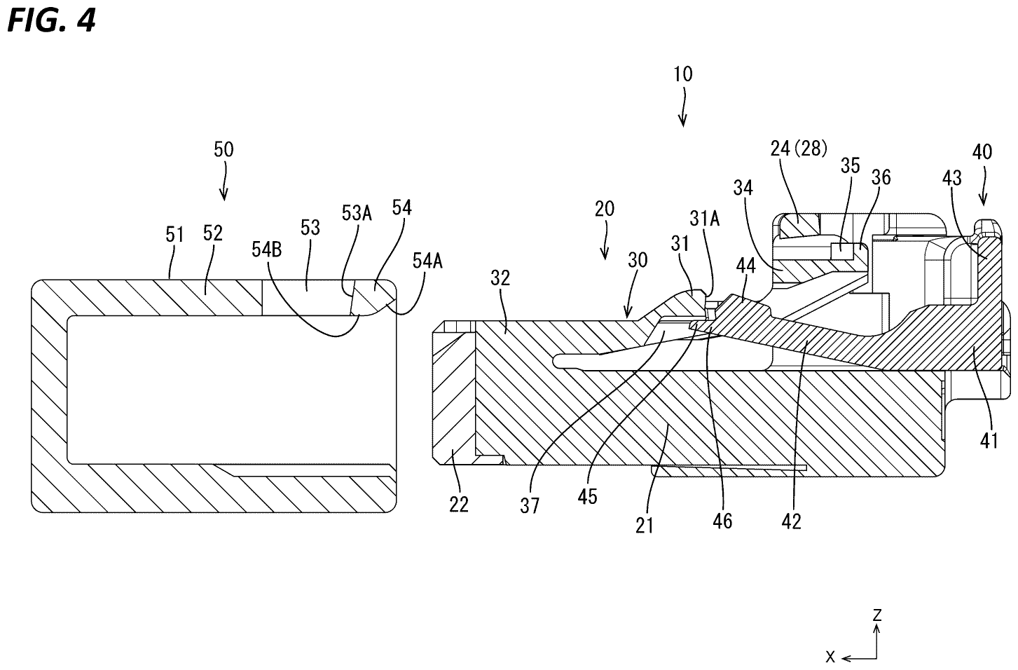

As shown in FIG. 4, the mating connector 50 includes a mating housing 51 e.g. made of a synthetic resin.

The mating housing 51 particularly includes a tubular hood portion 52 that substantially is open at the front.

A lock reception portion 53 particularly is formed at (particularly a front end portion of) an upper wall of the hood portion 52. The lock reception portion 53 specifically penetrates the upper wall substantially in a vertical direction.

A front surface of an inner wall of the lock reception portion 53 particularly is defined as a reverse-tapered engagement reception surface 53A having a slightly outward or upward slope toward the front.

An interference portion 54 particularly is formed substantially in front of the lock reception portion 53 at the front end portion of the upper wall of the hood portion 52.

A tapered inclined surface 54A having an outward or upward slope toward the front particularly is formed at or near (particularly a lower end portion of a front surface of) the interference portion 54.

A lower surface of the interference portion 54 particularly is defined or acts as a pressing surface 54B arranged substantially horizontally from the inclined surface 54A to the lock reception portion 53.

### (Housing 20)

The housing 20 e.g. is made of a synthetic resin.

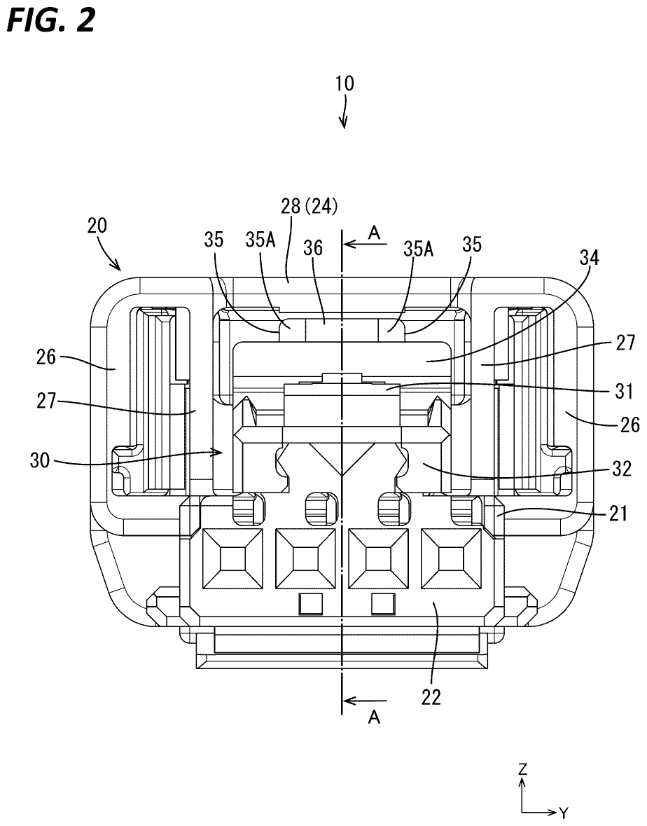

As shown in FIGS. 1 and 2, the housing 20 includes a (particularly substantially block-shaped) housing main body 21, a front cover 22 attached to (particularly a front surface of) the housing main body 21, and/or the lock arm 30 integrally or unitarily connected to (particularly an upper or lateral surface of) the housing main body 21.

The lock arm 30 particularly substantially extends diagonally upward or outward and rearward in a cantilever shape from (particularly the upper or lateral surface of) the housing main body 21.

The lock arm 30 is capable of undergoing bending deformation substantially in the vertical direction or towards and away from the housing main body 21.

A terminal metal fixture (not shown) can be at least partly inserted into the housing main body 21.

As shown in FIG. 1, an (particularly substantially arch-shaped) excessive bending restriction portion 24 at least partly surrounding a release operation portion 34 (described below) of the lock arm 30 is formed on the upper or lateral surface of (particularly a rear end portion of) the housing main body 21.

An inner space of the excessive bending restriction portion 24 particularly is defined as a mounting space 25 into which the detection member 40 at least partly is inserted or insertable from an insertion side, particularly substantially from behind.

The excessive bending restriction portion 24 particularly includes on ore more outer walls 26, particularly a pair of substantially bilaterally symmetrical outer walls 26, rising upward or outward from one or more (particularly both) end portions in a left-right direction of the upper surface of the housing main body 21, one or more, particularly a pair of lateral (left and/or right) inner walls 27 positioned particularly at an inner side of the outer wall(s) 26 and rising upward or outward from the upper or outer surface of the housing main body 21.

The excessive bending restriction portion 24 particularly includes a (particularly substantially horizontal flat) bridge portion 28 continuous with upper end(s) of the one or more (particularly of both of) the inner walls 27 and/or the one or more (particularly both of) the outer walls 26 and particularly provided to span an entire width of the housing main body 21.

Specifically, the bridge portion 28 is supported at a lateral (left) end portion and/or an opposite lateral (right) end portion thereof by, respectively, the one or more, particularly two pairs of outer walls 26 and/or inner walls 27 laterally spaced apart from each other.

A lower surface of the bridge portion 28 particularly is defined or acts as an upper-side restriction surface 28A.

The upper-side restriction surface 28A particularly substantially is a tapered surface sloping downward or inwardly as the upper-side restriction surface 28A extends forward.

### (Lock Arm 30)

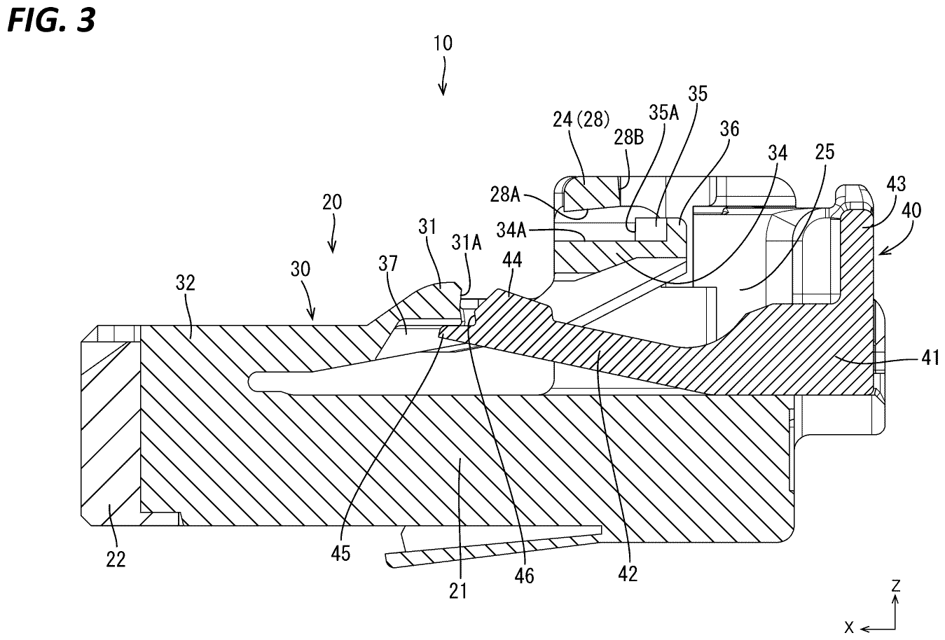

As shown in FIG. 3, the lock arm 30 substantially extends rearward in a cantilever shape from the outer or upper surface of (particularly a front end portion of) the housing main body 21.

A bending space particularly is formed between (particularly a lower surface of) the lock arm 30 and (particularly the upper surface of) the housing main body 21 for allowing resilient or elastic bending of the lock arm 30 during a process of fitting the connector 10 to the mating connector 50.

At least one lock protuberance 31 particularly is formed protruding upward or outward at substantially a central portion in the front-rear direction of the lock arm 30.

A rear surface of the lock protuberance 31 is defined or acts as an engagement surface 31A that particularly is open at the rear.

An upper portion side of the engagement surface 31A substantially opposite the engagement reception surface 53A of the lock reception portion 53 particularly is slightly reverse-tapered, and/or a lower portion side opposite an abutting portion 46 (described below) of the detection member 40 particularly is slightly tapered.

The lock arm 30 particularly includes a proximal end portion 32 substantially positioned in front of the lock protuberance 31.

The proximal end portion 32 particularly is connected to the upper or outer surface of the housing main body 21 and functions as a fulcrum for a bending operation of the lock arm 30.

As shown in FIG. 1, the lock arm 30 particularly includes one or more, particularly a pair of (particularly substantially bilaterally symmetrical) side frame portions 33 extending rearward laterally of (particularly from both left and right sides of) the lock protuberance 31, and/or the release operation portion 34 for performing a lock release operation for the lock arm 30.

As shown in FIGS. 1 and 3, the release operation portion 34 particularly substantially is formed in a rectangular plate shape.

An upper surface of the release operation portion 34 particularly is defined as a lower-side restriction surface 34A.

One or more, particularly a pair of lateral (left and/or right) protuberances 35, and particularly at least one rib 36 connecting (particularly rear ends of) these protuberances 35 to each other are formed on the lower-side restriction surface 34A.

The pair of protuberances 35 and the rib 36 particularly substantially are shaped like a gate that opens at the front when viewed from above as a whole.

In the front-rear direction, a front edge of the release operation portion 34 particularly is set to substantially the same position as a front edge of the bridge portion 28.

A rear edge of the release operation portion 34 particularly is set to a position more rearward than a rear edge of the bridge portion 28.

Therefore, a front end-side region of the release operation portion 34 particularly at least partly is covered from outside or above by the bridge portion 28 particularly across an entire width in the left-right direction.

On the other hand, a rear end-side region of the release operation portion 34 particularly is not covered from outside or above by the bridge portion 28 and is open above.

A front surface of the protuberance 35 particularly is defined or acts as a rear-side engagement surface 35A.

On the other hand, a rear surface of the bridge portion 28 particularly is defined or acts as a front-side engagement surface 28B.

In the front-rear direction, the rear-side engagement surface 35A particularly is set to a position more rearward than the front-side engagement surface 28B.

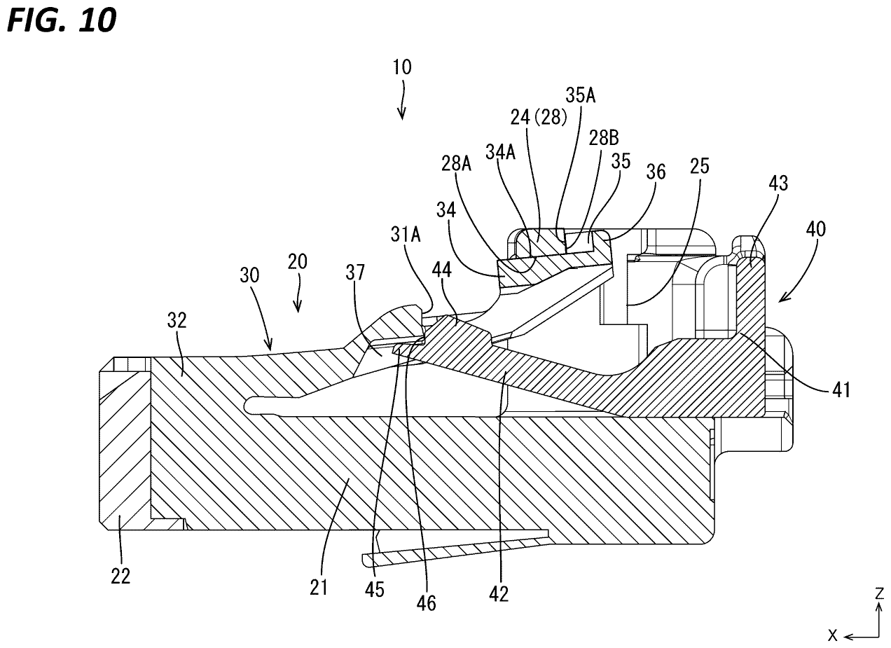

As shown in FIG. 10, when the lock arm 30 is lifted, forward movement (forward slipping) restriction of the lock arm 30 is firmly performed, due to the lower-side restriction surface 34A closely contacting and engaging with the upper-side restriction surface 28A substantially from below, and/or the rear-side engagement surface 35A closely contacting and engaging with the front-side engagement surface 28B substantially from behind.

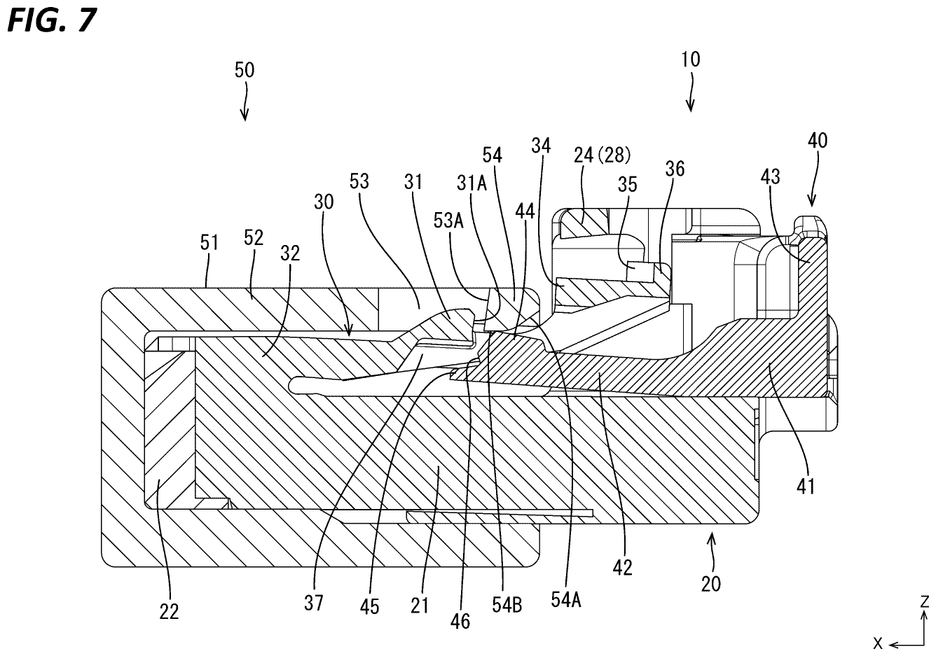

As shown in FIG. 7, in a state in which both of the connectors 10 and 50 are properly fitted to each other, the lock protuberance 31 particularly elastically fits at least partly into the lock reception portion 53 from below, the engagement surface 31A particularly is arranged so as to be capable of engaging with the engagement reception surface 53A, and/or both of the connectors 10 and 50 particularly are maintained in the properly fitted state.

On the other hand, in the state in which both of the connectors 10 and 50 are properly fitted to each other, the lock arm 30 particularly is caused to undergo bending deformation at least partly into the bending space by pressing down or inward the top or outer surface of the release operation portion 34. With this, the lock protuberance 31 particularly slips out from the lock reception portion 53, making it possible to separate both of the connectors 10 and 50.

As shown in FIG. 3, an accommodation recess portion 37 that substantially opens rearward particularly is formed on a lower surface of the lock arm 30.

In the front-rear direction, the accommodation recess portion 37 particularly is arranged at a position substantially corresponding to the lock protuberance 31.

Specifically, the accommodation recess portion 37 has a size and shape substantially conforming with a projection 44 (described below) of the detection member 40, and/or opens to the lower surface (bending space side) of the lock arm 30 and the rear surface of the lock protuberance 31.

### (Detection Member 40)

The detection member 40 e.g. is made of a synthetic resin.

The detection member 40 particularly includes a detection member main body 41 and/or an elastic arm portion 42 integrally or unitarily connected to (particularly a front end of) the detection member main body 41.

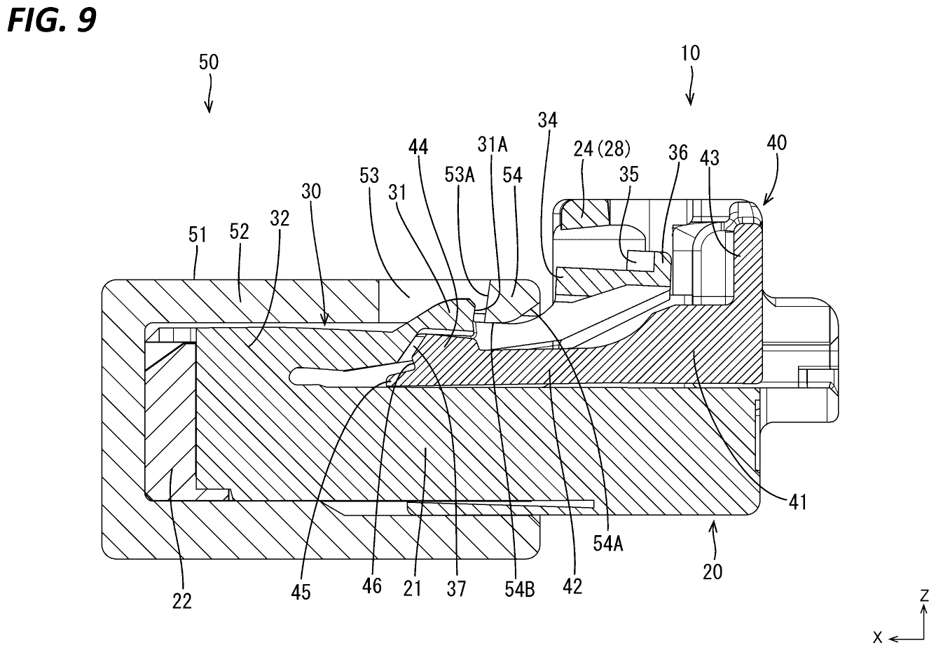

The detection member 40 particularly is mounted or mountable so to be movable from the initial position shown in FIG. 3 to the detection position shown in FIG. 9 via a standby position shown in FIG. 7.

An operation portion 43 particularly is formed protruding outward or upward at or near a rear end portion of an upper or outer surface of the detection member main body 41.

A finger or jig is or can be hooked onto the operation portion 43, and the detection member 40 is or may be restored from the detection position to the initial position by pulling rearward in this state.

The elastic arm portion 42 extends diagonally upward or outward and forward substantially in a cantilever shape from (particularly substantially a central portion in the left-right direction of a front surface of) the detection member main body 41.

Specifically, the elastic arm portion 42 substantially has a square or rectangular rod shape and/or is capable of undergoing bending deformation in the vertical direction substantially with the rear end portion continuous with (particularly the front surface of) the detection member main body 41 as a fulcrum.

In a natural state, the elastic arm portion 42 particularly is inclined upward at a roughly constant inclination angle from a rear end to a front end thereof.

As the detection member 40 is displaced from the initial position shown in FIG. 4 to the standby position shown in FIG. 7, the elastic arm portion 42 particularly is caused to undergo bending deformation so that the inclination angle thereof is gradually reduced.

The elastic arm portion 42 particularly assumes a substantially horizontal orientation without substantially tilting when the detection member 40 reaches the detection position shown in FIG. 9.

Accordingly, the elastic arm portion 42 is in a state of accumulated elastic force particularly in both the standby position and the detection position.

The block-shaped projection 44 particularly is formed protruding upward or outward at or near a front end portion of the elastic arm portion 42.

A contacting portion 45 particularly is formed substantially protruding forward at a lower front end portion of the projection 44.

As shown in FIG. 4, when the detection member 40 is in the initial position, an upper surface of the contacting portion 45 particularly is arranged roughly horizontally and/or contacts an upper surface of the accommodation recess portion 37 from below.

A region of the projection 44 rising upward from a rear end of the contacting portion 45 particularly is defined or acts as the abutting portion 46.

When the elastic arm portion 42 is in the natural state, the abutting portion 46 particularly is arranged so as to substantially extend in the vertical direction.

When the detection member 40 is in the initial position, the abutting portion 46 particularly is arranged so as to be substantially opposite the engagement surface 31A of the lock protuberance 31 from behind.

### (Description of Operation of Connector 10)

Next, an operation of the connector 10 will be described.

During mounting, the detection member 40 is first at least partly inserted from an insertion side, particularly substantially from behind, into the mounting space 25 of the housing main body 21.

When the detection member 40 has reached the initial position, the abutting portion 46 particularly is arranged so as to be capable of engaging with the engagement surface 31A of the lock protuberance 31 from behind.

Accordingly, when an attempt to press the detection member 40 forward in the initial position is made, the abutting portion 46 particularly contacts the engagement surface 31A and further forward movement of the detection member 40 is restricted.

In the initial position, the contacting portion 45 particularly contacts (particularly the upper surface of) an inner wall of the accommodation recess portion 37 (particularly from below), and/or the elastic arm portion 42 particularly is held while accumulating elastic force with respect to the lock arm 30.

An engagement margin between the abutting portion 46 and the engagement surface 31A of the lock protuberance 31 particularly is also automatically set to a specified (predetermined or predeterminable) value, due to the contacting portion 45 contacting the upper surface of the inner wall of the accommodation recess portion 37.

The elastic arm portion 42 particularly is prevented from being displaced upward or outward relative to the lock arm 30, in other words, the contact between the abutting portion 46 and the engagement surface 31A particularly is prevented from being released, due to the contacting portion 45 contacting the upper surface of the inner wall of the accommodation recess portion 37 from below.

Therefore, forward movement of the detection member 40 particularly is more reliably suppressed.

Here, a case is conceivable in which the detection member 40 is pressed forward by receiving an external force or the like.

In this case, the entire lock arm 30 first particularly swings substantially with the proximal end portion 32 as a fulcrum due to the abutting portion 46 contacting the engagement surface 31A from behind.

As shown in FIG. 10, the lock arm 30 particularly next swings due to the contacting portion 45 contacting the inner wall of the accommodation recess portion 37 from below.

The lock arm 30 particularly then stops swinging due to the lower-side restriction surface 34A of the release operation portion 34 contacting the upper-side restriction surface 28A of the bridge portion 28 from below.

When further pressing the detection member 40 forward from this state, the entire lock arm 30 particularly undergoes substantially diagonally upward and forward bending deformation, and/or the release operation portion 34 of the lock arm 30 particularly attempts to substantially move forward relative to the excessive bending restriction portion 24.

However, in the connector 10 of the present disclosure, forward movement of the lock arm 30 particularly is firmly restricted, due to the lower-side restriction surface 34A closely contacting the upper-side restriction surface 28A and/or the rear-side engagement surface 35A of the protuberance 35 closely contacting the front-side engagement surface 28B of the bridge portion 28.

In this way, the lock arm 30 slipping forward and detaching from the excessive bending restriction portion 24 is suppressed.

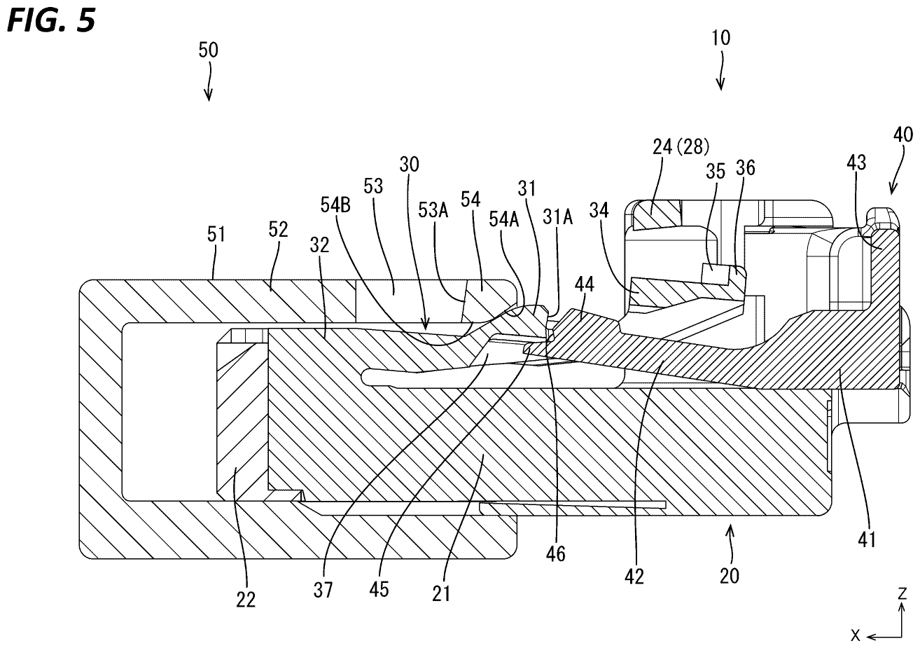

As shown in FIG. 5, in a fitting process of the housing main body 21 being fitted into the hood portion 52 of the mating housing 51, the lock arm 30 and the elastic arm portion 42 particularly undergo downward or inward bending deformation due to the lock protuberance 31 sliding against the inclined surface 54A of the interference portion 54.

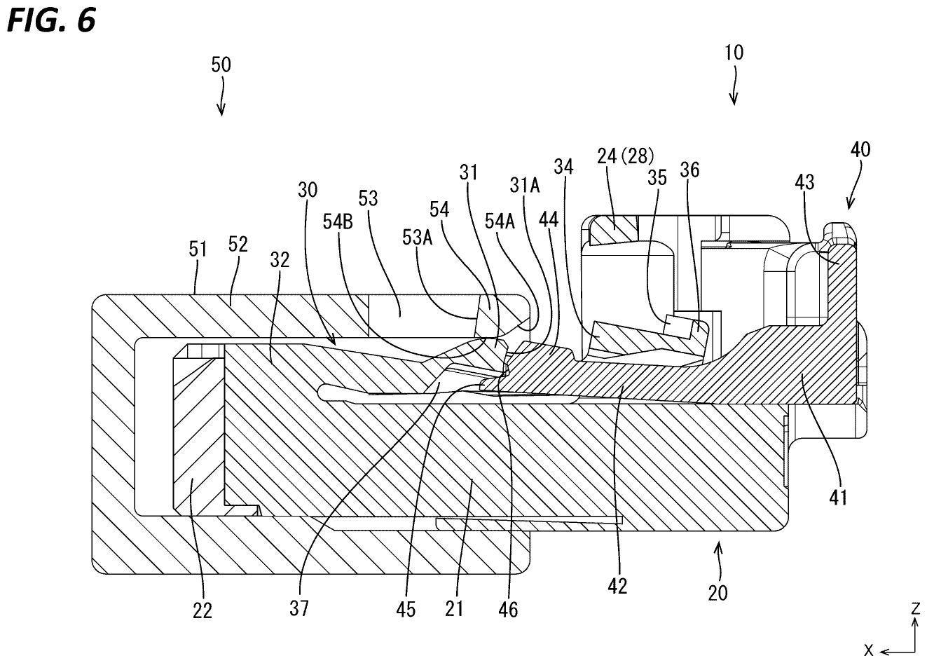

Subsequently, as shown in FIG. 6, the lock protuberance 31 particularly is pressed against the pressing surface 54B of the interference portion 54 and/or the lock arm 30 at least partly is accommodated in the bending space.

When the housing 20 substantially is properly fitted to the mating housing 51, a pressing state from the interference portion 54 against the lock protuberance 31 particularly is released, and as shown in FIG. 7, the lock arm 30 at least partly elastically returns and/or the lock protuberance 31 at least partly fits into the lock reception portion 53 from below.

With this, the upper portion of the engagement surface 31A of the lock protuberance 31 particularly is positioned so as to be capable of engaging with the engagement reception surface 53A of the lock reception portion 53, and/or both of the housings 20 and 51 are maintained in the properly fitted state.

When the housing 20 is properly fitted to the mating housing 51, the projection 44 particularly is pressed downward or inward by the interference portion 54.

At this time, the projection 44 does not follow a return operation of the lock arm 30 and/or maintains a contacting state with the interference portion 54, and the contacting portion 45 particularly detaches from the accommodation recess portion 37.

With this, the detection member 40 particularly is retained in the standby position in which the elastic arm portion 42 is separated from the lock arm 30 and/or contacts the mating housing 51. In the standby position, the elastic arm portion 42 particularly is caused to undergo bending deformation by the interference portion 54 and assumes a nearly horizontal tilted orientation.

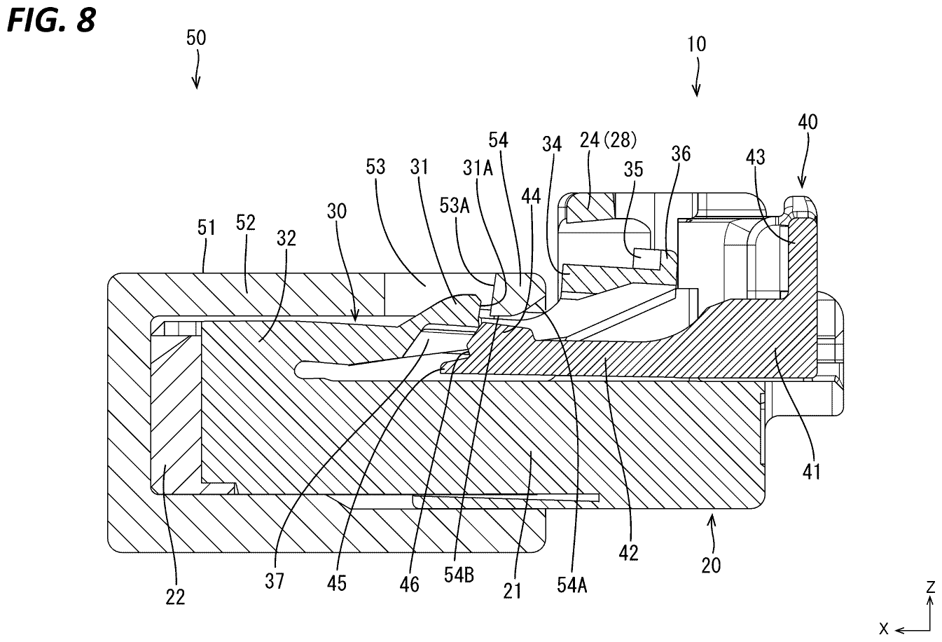

As shown in FIG. 8, when a forward pressing force is applied to the detection member 40 in the standby position, the elastic arm portion 42 particularly undergoes substantially downward or inward bending deformation and/or the projection 44 particularly at least partly is inserted into the accommodation recess portion 37 from behind, due to an inclined surface of the projection 44 sliding against a lower end of the engagement surface 31A.

As shown in FIG. 9, when the detection member 40 reaches the detection position, the projection 44 particularly at least partly is fitted into and accommodated in the accommodation recess portion 37.

Further forward movement of the detection member 40 particularly is restricted due to the projection 44 contacting a front surface of the inner wall of the accommodation recess portion 37.

In the detection position, the elastic arm portion 42 particularly is maintained in the state of accumulated elastic force between the lock arm 30 and the housing main body 21 particularly in a roughly horizontal orientation.

The elastic arm portion 42 particularly at least partly is inserted into the bending space of the lock arm 30 at a proper depth, thereby restricting the bending operation of the lock arm 30, and as a result, both of the housings 20 and 51 are maintained in the properly fitted state.

On the other hand, as shown in FIG. 6, when the housing 20 remains in a semi-fitted state without being properly fitted to the mating housing 51, the lock arm 30 particularly is pressed against the pressing surface 54B of the interference portion 54 and/or remains in a bending-deformed state.

Therefore, even when an attempt to push the detection member 40 forward is made in this state, the projection 44 particularly interferes with the lock protuberance 31 to keep the elastic arm portion 42 from at least partly entering the bending space of the lock arm 30, and/or movement of the detection member 40 to the detection position is prevented.

Therefore, it is possible to know whether the housing 20 is properly fitted to the mating housing 51, based on whether the detection member 40 can move to the detection position.

In order to separate both of the housings 20 and 51 maintained in the properly fitted state, the finger or jig particularly is or can be first fastened to or placed on the operation portion 43 and the detection member 40 is or can be pulled rearward in that state.

The detection member 40 particularly is restored toward or to the initial position due to a rearward pulling force acting on the detection member 40.

Subsequently, the finger or jig is fastened to or placed on the rib 36, and the release operation portion 34 particularly is pressed downward or inward.

At this time, the bridge portion 28 at least partly is arranged above the release operation portion 34, but the unlock operation can be performed since the rib 36 particularly is positioned more rearward than a rear end of the bridge portion 28.

Here, since the rib 36 particularly is integrally or unitarily formed with the one or more, particularly the pair of protuberances 35 and/or has high rigidity, the shape of the rib 36 is maintained substantially without collapsing even when a firm force is applied to the rib 36 by the finger or jig.

When performing the unlock operation on the release operation portion 34, the lock arm 30 particularly undergoes downward or inward elastic bending, the lock protuberance 31 particularly is separated from the lock reception portion 53, and/or an engagement state between the lock arm 30 and the lock reception portion 53 is released.

Subsequently, both of the housings 20 and 51 are or can be separated from each other by pulling the housing 20 away from the mating housing 51 while maintaining a state in which the release operation portion 34 is pressed down.

### Operation and Effects of Embodiment

The connector 10 according to the embodiment at least partly is fittable to the mating connector 50.

The connector 10 includes the housing 20 including the lock arm 30, and the detection member 40 mounted to or onto the housing 20 (particularly from behind) and movable forward from the initial position toward or to the detection position.

The lock arm 30 particularly substantially extends rearward in a cantilever shape from an outer surface of the housing 20.

The detection member 40 includes the detection member main body 41, the elastic arm portion 42 substantially extending forward in a cantilever shape from the detection member main body 41, and/or the abutting portion 46 formed at (particularly an extension end portion of) the elastic arm portion 42 and restricting movement from the initial position to the detection position by engaging with the lock arm 30 from behind.

The excessive bending restriction portion 24 restricting excessive bending of the lock arm 30 by engaging with the extension end portion of the lock arm 30 particularly is formed at the outer surface of the housing 20.

The protuberance 35 restricting forward movement of the lock arm 30 by engaging with the excessive bending restriction portion 24 during excessive bending restriction particularly is formed at the extension end portion of the lock arm 30.

When fitting the connector 10 to the mating connector 50, the lock arm 30 undergoes bending deformation, and in conjunction therewith, the elastic arm portion 42 of the detection member 40 also undergoes bending deformation.

When the mating connector 50 and the connector 10 substantially are properly fitted to each other, only the lock arm 30 particularly at least partly is returned and the elastic arm portion 42 remains in the bending-deformed state.

Subsequently, it is possible to particularly detect that the mating connector 50 and the connector 10 have reached the properly fitted state by causing the detection member 40 to move from the initial position to the detection position.

Before fitting the connector 10 to the mating connector 50, when a force or the like is unexpectedly applied to the detection member 40 to cause the detection member 40 to be pushed from the initial position toward the detection position, and/or the lock arm 30 is lifted due to the abutting portion 46 of the elastic arm portion 42 engaging with the lock arm 30 particularly from behind, excessive bending of the lock arm 30 particularly is restricted due to the extension end portion of the lock arm 30 engaging with the excessive bending restriction portion 24.

When further pressing the detection member 40 from this state, the substantially entire lock arm 30 particularly undergoes bending deformation and the extension end portion of the lock arm 30 attempts to move forward relative to the excessive bending restriction portion 24.

However, in the connector 10 of the embodiment, forward movement of the lock arm 30 particularly is restricted due to the protuberance 35 formed at (particularly the extension end portion of) the lock arm 30 engaging with the excessive bending restriction portion 24.

Therefore, the extension end portion of the lock arm 30 particularly detaches from the excessive bending restriction portion 24 and the abutting portion 46 of the detection member 40 particularly does not slip underneath the lock arm 30.

The lock arm 30 preferably extends diagonally upward (or outward) and rearward from the upper (or outer) surface of the housing 20.

The excessive bending restriction portion 24 preferably restricts excessive upward bending of the lock arm 30 by engaging with the extension end portion of the lock arm 30 from above.

Because the lock arm 30 extends diagonally upward (or outward) and rearward from the upper (or outward) surface of the housing 20, the lock arm 30 is more easily lifted due to the abutting portion 46 of the elastic arm portion 42 engaging with the lock arm 30 from behind.

However, as described above, excessive bending of the lock arm 30 particularly is restricted due to the extension end portion of the lock arm 30 engaging with the excessive bending restriction portion 24 and forward movement of the lock arm 30 is restricted by the protuberance 35.

The lower-side restriction surface 34A is preferably formed at an extension portion of the lock arm 30.

The excessive bending restriction portion 24 preferably includes the upper-side restriction surface 28A contacting the lower-side restriction surface 34A during excessive bending restriction.

The upper-side restriction surface 28A is preferably a tapered surface sloping downward as the upper-side restriction surface 28A extends forward.

Because the upper-side restriction surface 28A particularly is a tapered surface, the lower-side restriction surface 34A is more easily caused to closely contact the upper-side restriction surface 28A, and/or the lock arm 30 is more easily and securely fixed by the excessive bending restriction portion 24.

The protuberance 35 is preferably formed on the lower-side restriction surface 34A of the lock arm 30.

The excessive bending restriction portion 24 preferably includes the front-side engagement surface 28B with which the protuberance 35 engages from behind during forward movement restriction.

The front-side engagement surface 28B is preferably a tapered surface sloping upward as the front-side engagement surface 28B extends forward.

Because the front-side engagement surface 28B particularly is a tapered surface, the protuberance 35 engages more strongly with and detaches less likely from the front-side engagement surface 28B, and forward movement restriction of the lock arm 30 by the protuberance 35 can be performed firmly.

A pair of the protuberances 35 are preferably provided in parallel, and the pair of protuberances 35 are preferably connected by the rib 36 so as to form the gate shape that opens at the front.

The finger or jig particularly is more easily hooked onto the rib 36 when unlocking the lock arm 30 and release performance is more easily enhanced.

Rigidity particularly is increased by connecting the pair of protuberances 35 with the rib 36, and/or deformation of the rib 36 by an external force is more easily suppressed.

The protuberance 35 preferably includes the rear-side engagement surface 35A engaging with the front-side engagement surface 28B from behind.

The rear-side engagement surface 35A is preferably a tapered surface sloping upward as the rear-side engagement surface 35A extends forward.

Because the rear-side engagement surface 35A particularly is a tapered surface, the rear-side engagement surface 35A can more easily be caused to closely contact the front-side engagement surface 28B, and forward movement restriction of the lock arm 30 can be more firmly performed by the protuberance 35.

### OTHER EMBODIMENTS

The above embodiment can be modified and implemented as follows. The above embodiment and the following modified examples can be implemented in combination without technically contradicting each other.
In the above embodiment, the protuberance 35 particularly is formed on the release operation portion 34, but a protuberance may be formed on the excessive bending restriction portion 24, and forward movement restriction of the lock arm 30 may be performed by causing this protuberance to engage with the release operation portion 34 from the front.
In the above embodiment, the lock arm 30 being formed at the upper surface of the housing main body 21 is exemplified, but the lock arm 30 may be formed at the outer surface of the housing main body 21 or may be formed at a side surface, a lower surface, or the like of the housing main body 21.
In the above embodiment, the lock arm 30 extending diagonally upward and rearward from the upper surface of the housing main body 21 is exemplified, but the lock arm may extend rearward parallel to the upper surface of the housing main body 21.
In the above embodiment, the upper-side restriction surface 28A being a tapered surface is exemplified, but an upper-side engagement surface substantially may be parallel to the upper surface of the housing main body 21.
In the above embodiment, the front-side engagement surface 28B being a tapered surface is exemplified, but a front-side engagement surface substantially may be perpendicular to the upper surface of the housing main body 21.
In the above embodiment, the pair of protuberances 35 being connected by the rib 36 is exemplified, but the number of protuberances 35 may be one or three or more, and the rib 36 may be omitted.
In the above embodiment, the rear-side engagement surface 35A being a tapered surface is exemplified, but a rear-side engagement surface may be perpendicular to the upper surface of the housing main body 21.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector fittable to a mating connector, comprising:
a housing including at least one lock arm; and
at least one detection member mounted onto the housing and movable forward from an initial position to a detection position, wherein
the lock arm extends rearward in a cantilever shape from an outer surface of the housing,
the detection member includes a detection member main body, an elastic arm portion extending forward in a cantilever shape from the detection member main body, and an abutting portion formed at the elastic arm portion and restricting a movement from the initial position to the detection position by engaging with the lock arm,
an excessive bending restriction portion is formed at an outer surface of the housing, the excessive bending restriction portion restricting excessive bending of the lock arm by engaging with the lock arm, and
at least one protuberance is formed on at least one of the extension end portion of the lock arm or the excessive bending restriction portion, the protuberance restricting forward movement of the lock arm by engaging with the other during excessive bending restriction.

2. The connector according to claim 1, wherein
the lock arm extends diagonally upward and rearward from an upper surface of the housing, and/or
the excessive bending restriction portion restricts excessive upward or outward bending of the lock arm by engaging with the extension end portion of the lock arm from above.

3. The connector according to claim 2, wherein
a lower-side restriction surface is formed at or near an extension portion of the lock arm, and/or
the excessive bending restriction portion includes an upper-side restriction surface to contact the lower-side restriction surface during excessive bending restriction.

4. The connector according to claim 3, wherein the upper-side restriction surface is a tapered surface sloping downward as the upper-side restriction surface extends forward.

5. The connector according to claim 4, wherein
the protuberance is formed on the lower-side restriction surface of the lock arm, and/or
the excessive bending restriction portion includes a front-side engagement surface with which the protuberance engages substantially from behind during forward movement restriction.

6. The connector according to claim 5, wherein the front-side engagement surface is a tapered surface sloping upward as the front-side engagement surface extends forward.

7. The connector according to claim 5, wherein
a pair of the protuberances are provided substantially in parallel, and
the pair of protuberances are connected by at least one rib so as to form a gate shape that substantially opens at a front.

8. The connector according to claim 6, wherein
the protuberance includes a rear-side engagement surface engaging with the front-side engagement surface from behind, and/or
the rear-side engagement surface is a tapered surface sloping upward as the rear-side engagement surface extends forward.

9. A connector assembly comprising the connector according to claim 1 and a mating connector connectable therewith.
